(19) United States
(12) Patent Application Publication
(10) Pub. No.: US 2024/0164573 A1
(43) Pub. Date: May 23, 2024

(54) Microwaveable Food Cover Device

(71) Applicant: John Jefferson, Las Vegas, NV (US)

(72) Inventor: John Jefferson, Las Vegas, NV (US)

(21) Appl. No.: 18/349,215

(22) Filed: Jul. 10, 2023

Related U.S. Application Data
(60) Provisional application No. 63/426,177, filed on Nov. 17, 2022.

(51) Int. Cl. A47J 36/02; A23L 5/10; B65D 51/16

(52) U.S. Cl. CPC A47J 36/027; A23L 5/13; A23L 5/15; B65D 51/16; B65D 2205/02

(57) ABSTRACT

The present invention relates to a novel microwaveable food cover device. The device is a food-safe, microwaveable container with a water supply for preventing dehydration of food as it is heated. The microwaveable food cover device comprises a body component for covering a user's food while in the microwave. The body component comprises a plurality of through-holes to allow moisture inside the cover. Further, a water cup is secured to the side of the body component which is filled with water during use to create moisture. Users can pour water into the cup attached to the side of the body component. The water adds moisture to the food via the plurality of through-holes to prevent heat from drying it up. The device can also help prevent food splatter to keep a microwave clean.

### CROSS-REFERENCE TO RELATED APPLICATION

The present application claims priority to, and the benefit of, U.S. Provisional Application No. 63/426,177, which was filed on Nov. 17, 2022, and is incorporated herein by reference in its entirety.

### FIELD OF THE INVENTION

The present invention relates generally to the field of microwaveable food cover devices. More specifically, the present invention relates to a microwaveable food cover device that provides users with a food cover for microwaved dishes, which is capable of preventing splatter while infusing moisture into food. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in microwaveable food cover devices. Generally, heating up food in a microwave can be a simple and convenient process to enjoy a nice, hot meal. However, some items may need to be microwaved for longer periods of time to be fully warmed up, leading to these items getting dried out. Accordingly, microwaving food prevents moisture from reaching the food and keeping it edible. Specifically, food that is heated up by a microwave becomes dry and hard because water inside the food is vaporized and escapes from the food. Further, trying to eat food like pizza or vegetables that are dried out can be unenjoyable.

Accordingly, a need remains for a microwaveable food cover device that prevents food from splattering when using a microwave. Further, the microwaveable food cover device needs to infuse the food with moisture to prevent the food from drying out as well.

Therefore, there exists a long-felt need in the art for a microwaveable food cover device that provides users with a food cover for microwaved dishes capable of preventing splatter while infusing moisture into food. There is also a long-felt need in the art for a microwaveable food cover device that allows users to cover their food and heat it in the microwave without worry of it drying out and becoming inedible. Further, there is a long-felt need in the art for a microwaveable food cover device that includes a small water cup on the side of the cover that distributes moisture to heated food via several holes in the cover. Moreover, there is a long-felt need in the art for a device that offers a simple and convenient cover that can help people quickly heat their meals to an enjoyable temperature while preventing them from drying out. Further, there is a long-felt need in the art for a microwaveable food cover device that comprises a handle for easily applying and removing the cover. Finally, there is a long-felt need in the art for a microwaveable food cover device that is washable and reusable.

The subject matter disclosed and claimed herein, in one embodiment thereof, comprises a microwaveable food cover device. The device is a food-safe, microwaveable container with a water supply for preventing dehydration of food as it is heated. The microwaveable food cover device comprises a body component for covering a user's food while in the microwave. The body component comprises a plurality of through-holes to allow moisture inside the cover. Further, a water cup is secured to the side of the body component which is filled with water during use to create moisture. Thus, the water supply in the cup keeps the food from dehydrating when put into the microwave. Users can pour water into the cup attached to the side of the body component. The water adds moisture to the food via the plurality of through-holes to prevent heat from drying it up. The device can also help prevent food splatter to keep a microwave clean. Users can easily apply and remove the cover device via an attached handle.

In this manner, the microwaveable food cover device of the present invention accomplishes all of the foregoing objectives and provides users with a device that prevents splatters in a microwave and provides moisture while cooking. The device is a microwaveable cover for all types of food. The device can be manufactured in different sizes and shapes.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a microwaveable food cover device. The device is a food-safe, microwaveable container with a water supply for preventing dehydration of food as it is heated. The microwaveable food cover device comprises a body component for covering a user's food while in the microwave. The body component comprises a plurality of through-holes or vent holes to allow moisture inside the cover. Further, a water cup is secured to the side of the body component which is filled with water during use to create moisture. Thus, the water supply in the cup keeps the food from dehydrating when put into the microwave.

Generally, the microwaveable food cover device is for use within a microwave oven to prevent splatter within the microwave cooking cavity during cooking. In this embodiment, the microwaveable food cover device is disposed within a microwave oven, having an optional rotatable carousel, with the microwaveable food cover device being disposed over a microwaveable dish or plate.

In one embodiment, the microwaveable food cover device comprises a body component which comprises a side wall and a top cover portion. The height of the side wall is approximately two inches to five inches, but can be any suitable shape and size as is known in the art. In some embodiments, the side wall is collapsible and/or expandable along the side wall. In other embodiments, the side wall is mechanically detachable/attachable to the top cover portion of the body component. In some other embodiments, the side wall is detachable/attachable to the top cover portion, such as with a locking mechanism.

In one embodiment, the body component is rigid, not bendable. In some other embodiments, the body component is flexible such that it can snugly fit, such as deformation by gravity, most of the contour of the top of a food container.

In another embodiment, the microwaveable food cover device comprises a body component that includes a side wall and a dome-shaped housing (as the top cover portion), with a plurality of through-holes or vent holes positioned at the top of the dome. The plurality of through-holes provide venting and facilitates air flow from a lower part of the dome housing up to a dome apex or top or upper portion of the dome housing, such that air flows up through the plurality of ventilation holes at the top of the housing. Specifically, the plurality of vent holes or through-holes allow steam to flow into the space under/inside the body component to add moisture to the reheated food.

In some embodiments, the body component comprises a liquid storage area or water cup component. The water cup component can be a concave and/or recessed within any part of the body component or the water cup component can be a separate compartment that can be removably or permanently secured to the body component. In some embodiments, the water cup component is able to be instantly attached to and detached from the body component by a pinch/snap-and-push action of a user's fingers. The water cup component can be any suitable shape and size as is known in the art, depending on the wants and/or needs of a user, as well as depending on the size of the body component. Typically, the larger the body component, the larger the water cup component.

Further, the water cup component comprises an external handle that allows a user to grasp it when filling the water cup component with water. The water cup component is used for liquid storage. The water cup component is bowl or cup shaped. In some embodiments, the water cup component contains an amount meter for measuring an amount of liquid that is added. In some embodiments, the meter comprises scales in cubic centimeter (cc), such that a user is able to measure the amount of liquid (such as water) that is added to the water cup component.

In some embodiments, the body component and the water cup component are made separately and then molded together. In some embodiments, the body component and the water cup component are formed simultaneously in an injection mold.

In some embodiments, the body component is able to be made of polypropylene and the water cup component is able to be made of silicone. A person of ordinary skill in the art appreciates that any other materials are able to be used to make the body component and its components, such as the handle and the water cup component. The materials are able to be any polymeric materials, such as polyethylene (PE), polyvinyl chloride (PVC), acrylonitrile butadiene styrene (ABS), polycarbonate (PC), etc., or any combination thereof, and any other suitable materials.

In use, a user is able to cover a plate of food to be warmed within a microwave oven with the microwaveable food cover device. Water is added to the water cup component and then the cover device is placed over the plate of food and positioned within the microwave oven. The microwave oven is then started for a pre-determined time, such as one minute. While cooking, the added water in the water cup component is converted into steam and transported through the plurality of through-holes to lock moisture into the food.

Accordingly, the water cup component acts as a steam generator and water in the water cup component is vaporized into steam during cooking. The term steam is able to be used interchangeably with the term vapor, water vapor, or heated moisture in some embodiments. The steam comes out from the water cup component and into the through-holes and remains confined within/under the body component, and forms a vapor covered environment so that the food to be reheated is able to remain moist. A person of ordinary skill the art appreciates that other fluids, gels, and/or solids are able to be used to replace or used together with the water in the water cup component. For example, a vitamin solid tablet or liquid is able to be added to the water to form a vitamin enhanced vapor.

In one embodiment, the microwaveable food cover device comprises a handle secured to the top of the body component for transporting the cover device. The lid can be secured via any suitable means as is known in the art. A user lifts the handle when moving/carrying the microwaveable food cover device during transportation. Further, the handle can comprise a covering which allows the handle to remain substantially cool to a user's touch and allows for easy grasping of the microwaveable food cover device during use. Additionally, in another embodiment, the cover device has at least two grip handles (on diametrically opposed sides of the housing, but not necessarily limited to such a design or location) extending from or around the outer rim of the cover device for easy lifting. Any suitable number of handles can be utilized as is known in the art, depending on the needs and/or wants of a user.

The microwaveable food cover device disclosed herein is able to be used in reheating food. The meaning of “reheating food” includes heating food that has been previously cooked. The microwaveable food cover device disclosed herein is also able to be used to cook food. The meaning of “cook food” includes turning raw food or uncooked edible material or substance to a cooked state or more cooked state, such as from raw to rare, from rare to medium well, or from raw to well done or over cooked.

In yet another embodiment, the microwaveable food cover device comprises a plurality of indicia.

In yet another embodiment, a method of preventing food splatters while microwaving food is disclosed. The method includes the steps of providing a microwaveable food cover device comprising a body component with a plurality of through-holes, a water cup, and a handle. The method also comprises filling up the water cup with water. Further, the method comprises placing the microwaveable food cover device over a plate of food in the microwave via the handle. Finally, the method comprises microwaving the food without worry of splattering and while infusing moisture into the food.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the microwaveable food cover device of the present invention showing the cover and the attached water cup in accordance with the disclosed architecture;

FIG. 2 illustrates a front perspective view of one embodiment of the microwaveable food cover device of the present invention showing the handle in accordance with the disclosed architecture;

FIG. 3 illustrates a front perspective view of one embodiment of the microwaveable food cover device of the present invention showing the holes which allow moisture inside the cover in accordance with the disclosed architecture;

FIG. 4 illustrates a front perspective view of one embodiment of the microwaveable food cover device of the present invention showing how the water cup is filled in accordance with the disclosed architecture;

FIG. 5 illustrates a front perspective view of one embodiment of the microwaveable food cover device of the present invention in use in accordance with the disclosed architecture; and

FIG. 6 illustrates a flowchart showing the method of preventing food splatters while microwaving food in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a microwaveable food cover device that provides users with a food cover for microwaved dishes capable of preventing splatter while infusing moisture into food. There is also a long-felt need in the art for a microwaveable food cover device that allows users to cover their food and heat it in the microwave without worry of it drying out and becoming inedible. Further, there is a long-felt need in the art for a microwaveable food cover device that includes a small water cup on the side of the cover that distributes moisture to heated food via several holes in the cover. Moreover, there is a long-felt need in the art for a device that offers a simple and convenient cover that can help people quickly heat their meals to an enjoyable temperature while preventing them from drying out. Further, there is a long-felt need in the art for a microwaveable food cover device that comprises a handle for easily applying and removing the cover. Finally, there is a long-felt need in the art for a microwaveable food cover device that is washable and reusable.

The present invention, in one exemplary embodiment, is a novel microwaveable food cover device. The device is a food-safe, microwaveable container with a water supply for preventing dehydration of food as it is heated. The microwaveable food cover device comprises a body component for covering a user's food while in the microwave. The body component comprises a plurality of through-holes to allow moisture inside the cover. Further, a water cup is secured to the side of the body component, which is filled with water during use to create moisture. Users can pour water into the cup attached to the side of the body component. The water adds moisture to the food via the plurality of through-holes to prevent heat from drying it up. The device can also help prevent food splatter to keep a microwave clean.

The present invention also includes a novel method of preventing food splatters while microwaving food. The method includes the steps of providing a microwaveable food cover device comprising a body component with a plurality of through-holes, a water cup, and a handle. The method also comprises filling up the water cup with water. Further, the method comprises placing the microwaveable food cover device over a plate of food in the microwave via the handle. Finally, the method comprises microwaving the food without worry of splattering and while infusing moisture into the food.

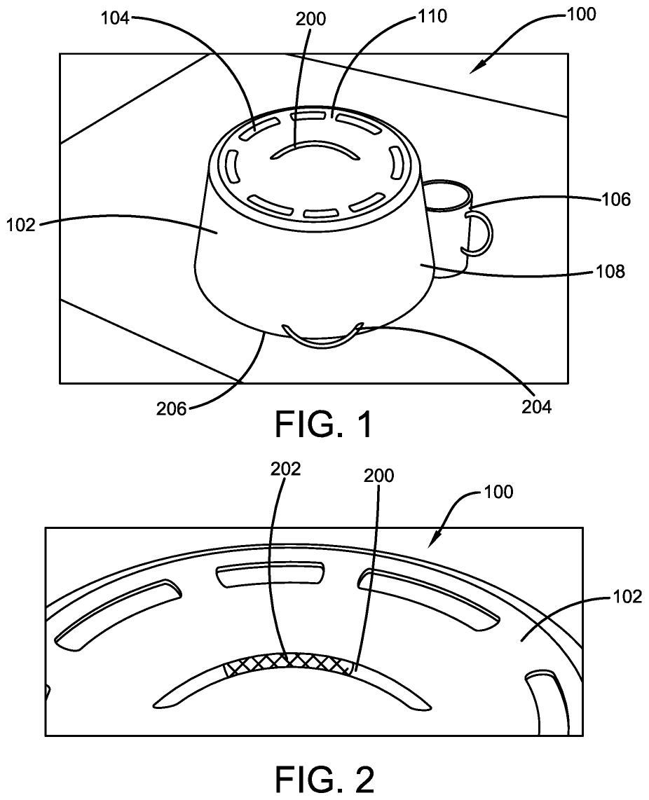

Referring initially to the drawings, FIG. 1 illustrates a perspective view of one embodiment of the microwaveable food cover device 100 of the present invention. In the present embodiment, the microwaveable food cover device 100 is an improved microwaveable food cover device 100 with a water supply for preventing dehydration of food as it is reheated in a microwave. Specifically, the microwaveable food cover device 100 comprises a body component 102 for covering a user's food while in the microwave. The body component 102 comprises a plurality of through-holes or vent holes 104 to allow moisture inside the cover device 100. Further, a water cup component 106 is secured to the side of the body component 102 which is filled with water during use to create moisture. Thus, the water supply in the cup component 106 keeps the food from dehydrating when put into the microwave.

Generally, the microwaveable food cover device 100 is for use within a microwave oven to prevent splatter within the microwave cooking cavity during cooking. In this embodiment, the microwaveable food cover device 100 is disposed within a microwave oven, having an optional rotatable carousel, with the microwaveable food cover device 100 being disposed over a microwaveable dish or plate 400.

In one embodiment, the microwaveable food cover device 100 comprises a body component 102 which comprises a side wall 108 and a top cover portion 110. The height of the side wall 108 is approximately two inches to five inches, but can be any suitable shape and size as is known in the art. Typically, the body component 102 (i.e., side wall 108 and top cover portion 110) is circular in shape, but can be any suitable shape as is known in the art, such as rectangular, oval, square, etc. In some embodiments, the side wall 108 is collapsible and/or expandable along the side wall 108. In other embodiments, the side wall 108 is mechanically detachable/attachable to the top cover portion 110 of the body component 102. In some other embodiments, the side wall 108 is detachable/attachable to the top cover portion 110 via a locking mechanism (not shown).

Furthermore, the body component 102 is rigid not bendable. However, in some other embodiments, the body component 102 is flexible, such that it can snugly fit and exhibit deformation by gravity, conforming to the top of a food container or plate 400.

As shown in FIG. 2, the microwaveable food cover device 100 comprises a handle 200 secured to the top 110 of the body component 102 for transporting the cover device 100. The handle 200 can be secured via any suitable securing means as is known in the art. A user lifts the handle 200 when moving/carrying the microwaveable food cover device 100 during transportation. Further, the handle 200 can comprise a covering 202 which allows the handle 200 to remain substantially cool to a user's touch and allows for easy grasping of the microwaveable food cover device 100 during use. Additionally, in another embodiment, the cover device 100 has at least two grip handles 204 (on diametrically opposed sides of the housing 102, but not necessarily limited to such a design or location) extending from or around the outer rim 206 of the cover device 100 for easy lifting. Any suitable number of handles 200 or 204 can be utilized as is known in the art, depending on the needs and/or wants of a user.

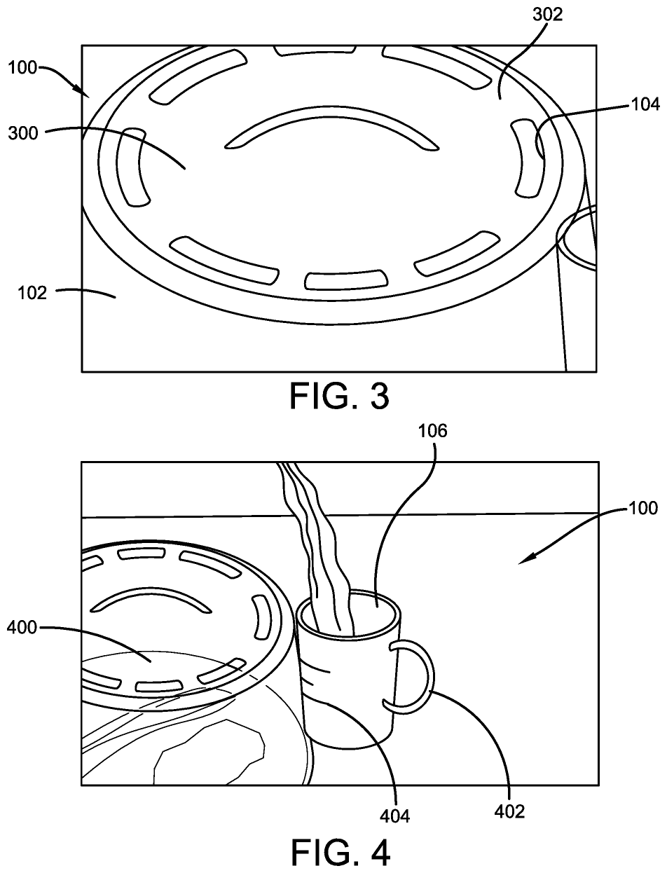

As shown in FIG. 3, the microwaveable food cover device 100 comprises a body component 102 that includes a side wall 108 and a dome-shaped housing 300 (as the top cover portion 110) with a plurality of through-holes or vent holes 104 positioned at the top 302 of the dome 300. The plurality of vent holes 104 can be positioned in any suitable position on the body component 102, as is known in the art, depending on the needs and/or wants of a user. The plurality of through-holes 104 provide venting and facilitates air flow from a lower part of the dome housing 300 up to a dome apex or top 302 or upper portion of the dome housing 300, such that air flows up through the plurality of ventilation holes 104 at the top 302 of the housing 102. Specifically, the plurality of vent holes or through-holes 104 allow steam to flow into the space under/inside the body component 102 to add moisture to the reheated food.

As shown in FIG. 4, the body component 102 comprises a liquid storage area or water cup component 106. The water cup component 106 can be a concave and/or recessed within any part of the body component 102 or the water cup component 106 can be a separate compartment that can be removably or permanently secured to the body component 102. In some embodiments, the water cup component 106 is able to be instantly attached to and detached from the body component 102 by a pinch/snap-and-push action of a user's fingers. The water cup component 106 can be any suitable shape and size as is known in the art, depending on the wants and/or needs of a user, as well as depending on the size of the body component 102. Typically, the larger the body component 102, the larger the water cup component 106.

Further, the water cup component 106 comprises an external handle 402 that allows a user to grasp it, when filling the water cup component 106 with water. The water cup component 106 is used for liquid storage. The water cup component 106 is bowl or cup shaped. In some embodiments, the water cup component 106 contains an amount meter 404 for measuring an amount of liquid that is added. In some embodiments, the meter 404 comprises scales in cubic centimeters (cc) or other suitable measuring units, such that a user is able to measure the amount of liquid (such as water) that is added to the water cup component 106.

In some embodiments, the body component 102 and the water cup component 106 are made separately and then molded together. In other embodiments, the body component 102 and the water cup component 106 are formed simultaneously in an injection mold, or any other suitable manufacturing means as is known in the art.

Generally, the body component 102 is manufactured of polypropylene and the water cup component 106 is manufactured of silicone. However, a person of ordinary skill in the art appreciates that any other materials are able to be used to make the body component 102 and its components, such as the handle 200 and the water cup component 106. The materials are able to be any suitable polymeric materials, such as polyethylene (PE), polyvinyl chloride (PVC), acrylonitrile butadiene styrene (ABS), polycarbonate (PC), etc., or any combination thereof, and any other suitable materials.

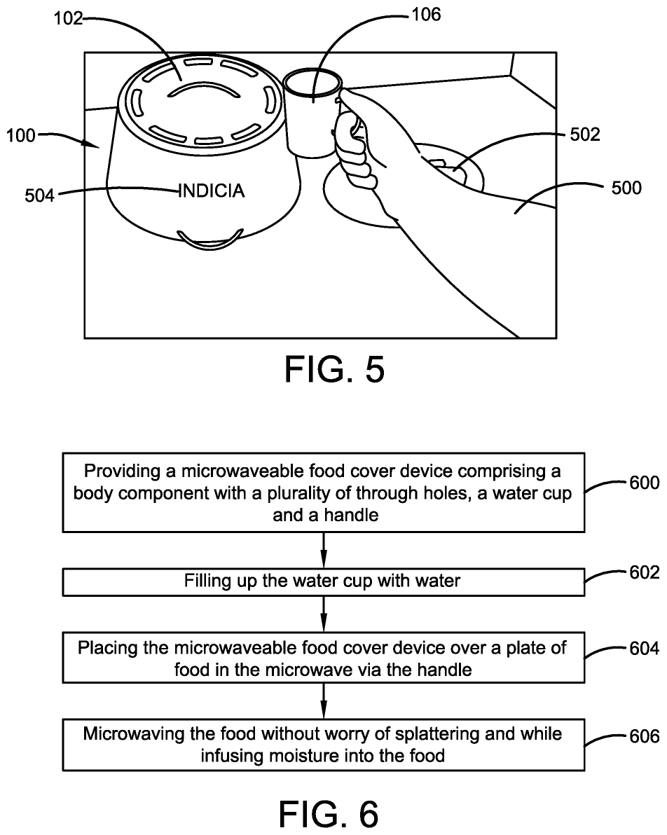

As shown in FIG. 5, in use, a user 500 is able to cover a plate 400 of food 502 to be warmed within a microwave oven with the microwaveable food cover device 100. Water is added to the water cup component 106 and then the cover device 100 is placed over the plate 400 of food 502 and positioned within the microwave oven. The microwave oven is then started for a pre-determined time, such as one minute. While cooking, the added water in the water cup component 106 is converted into steam and transported through the plurality of through-holes 104 to lock moisture into the food 502.

Accordingly, the water cup component 106 acts as a steam generator and water in the water cup component 106 is vaporized into steam during cooking. The term steam is able to be used interchangeably with the term vapor, water vapor, or heated moisture in some embodiments. The steam comes out from the water cup component 106 and into the through-holes 104, and then remains confined within/under the body component 102, and forms a vapor covered environment, so that the food 502 to be reheated is able to remain moist. A person of ordinary skill the art appreciates that other fluids, gels, and/or solids, are able to be used to replace or used together with the water in the water cup component 106. For example, a vitamin solid tablet or liquid is able to be added to the water to form a vitamin enhanced vapor.

The microwaveable food cover device 100 disclosed herein is able to be used in reheating food 502. The meaning of “reheating food” includes heating food 502 that has been previously cooked. The microwaveable food cover device 100 disclosed herein is also able to be used to cook food 502. The meaning of “cook food” includes turning raw food 502 or uncooked edible material or substance to a cooked state or more cooked state, such as from raw to rare, from rare to medium well, or from raw to well done or over cooked.

Further, the microwaveable food cover device 100 comprises a plurality of indicia 504. The body component 102 of the device 100 may include advertising, trademark, other letters, designs, or characters, printed, painted, stamped, or integrated into the body component 102, or any other indicia 504 as is known in the art. Specifically, any suitable indicia 504 as is known in the art can be included, such as, but not limited to, patterns, logos, emblems, images, symbols, designs, letters, words, characters, animals, advertisements, brands, etc., that may or may not be food, microwave, or brand related.

FIG. 6 illustrates a flowchart of the method of preventing food splatters while microwaving food. The method includes the steps of at 600, providing a microwaveable food cover device comprising a body component with a plurality of through-holes, a water cup, and a handle. The method also comprises at 602, filling up the water cup with water. Further, the method comprises at 604, placing the microwaveable food cover device over a plate of food in the microwave via the handle. Finally, the method comprises at 606, microwaving the food without worry of splattering while infusing moisture into the food.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “microwaveable food cover device”, “cover device”, and “device” are interchangeable and refer to the microwaveable food cover device 100 of the present invention.

Notwithstanding the foregoing, the microwaveable food cover device 100 of the present invention can be of any suitable size and configuration as is known in the art without affecting the overall concept of the invention, provided that it accomplishes the above-stated objectives. One of ordinary skill in the art will appreciate that the microwaveable food cover device 100 as shown in FIGS. 1-6 are for illustrative purposes only, and that many other sizes and shapes of the microwaveable food cover device 100 are well within the scope of the present disclosure. Although the dimensions of the microwaveable food cover device 100 are important design parameters for user convenience, the microwaveable food cover device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A microwaveable food cover device that prevents dehydration of food as it is reheated in a microwave, the microwaveable food cover device comprising:
a body component having a plurality of vent holes; and
a water cup component;
wherein the body component covers a user's food while in a microwave; and
further wherein the water cup component is filled with liquid during use to create moisture.

2. The microwaveable food cover device of claim 1, wherein the body component is disposed over a microwaveable plate to prevent splatter within a microwave cooking cavity during cooking.

3. The microwaveable food cover device of claim 2, wherein the body component comprises a side wall and a top cover portion.

4. The microwaveable food cover device of claim 3, wherein a height of the side wall is approximately two inches to five inches.

5. The microwaveable food cover device of claim 4, wherein the body component is circular in shape.

6. The microwaveable food cover device of claim 5, wherein the body component comprises a handle secured to a top of the body component for transportation.

7. The microwaveable food cover device of claim 6, wherein the handle comprises a covering which allows the handle to remain substantially cool to a user's touch during use.

8. The microwaveable food cover device of claim 1, wherein the body component comprises at least two grip handles on opposing sides of the body component.

9. The microwaveable food cover device of claim 1, wherein the body component comprises a side wall and a dome-shaped housing.

10. The microwaveable food cover device of claim 1, wherein the plurality of vent holes are positioned around a top of the body component.

11. The microwaveable food cover device of claim 1, wherein the water cup component is removably or permanently secured to the body component.

12. The microwaveable food cover device of claim 11, wherein the water cup component comprises an external handle that allows a user to grasp it, when filling the water cup component with liquid.

13. The microwaveable food cover device of claim 12, wherein the water cup component comprises an amount meter for measuring an amount of liquid that is added.

14. A microwaveable food cover device that prevents dehydration of food as it is reheated in a microwave, the microwaveable food cover device comprising:
a body component with a plurality of vent holes positioned around a top; and
a water cup component secured to a side of the body component;
wherein the body component is disposed over a microwaveable plate to prevent splatter within a microwave cooking cavity during cooking;
wherein the body component comprises a side wall and a top cover portion;
wherein a handle is secured to a top of the top cover portion for transportation;
wherein the water cup component is filled with liquid during use to create moisture; and
further wherein the liquid in the water cup component is converted into steam and transported through the plurality of vent holes to lock moisture into food.

15. The microwaveable food cover device of claim 14, wherein the handle comprises a covering which allows the handle to remain substantially cool to a user's touch during use.

16. The microwaveable food cover device of claim 14 further comprising a plurality of indicia.

17. The microwaveable food cover device of claim 14, wherein the water cup component comprises an external handle that allows a user to grasp it, when filling the water cup component with liquid.

18. The microwaveable food cover device of claim 17, wherein the water cup component comprises an amount meter for measuring an amount of liquid that is added.

19. The microwaveable food cover device of claim 14, wherein the body component comprises at least two grip handles on opposing sides of the body component.

20. A method of preventing food splatters while microwaving food, the method comprising the following steps:
providing a microwaveable food cover device comprising a body component with a plurality of through-holes, a water cup, and a handle;
filling up the water cup with water;
placing the microwaveable food cover device over a plate of food in the microwave via the handle; and
microwaving the food without worry of splattering and while infusing moisture into the food.
